(19) United States
(12) Patent Application Publication
(10) Pub. No.: US 2011/0075111 A1
(43) Pub. Date: Mar. 31, 2011

(54) VIDEO PROJECTOR

(75) Inventors: Shinya Noda, Daito-shi (JP); Nobuyuki Kondou, Moriguchi-shi (JP); Ken Mashitani, Neyagawa-shi (JP)

(73) Assignee: SANYO ELECTRIC CO., LTD., Osaka (JP)

(21) Appl. No.: 12/878,421

(22) Filed: Sep. 9, 2010

(30) Foreign Application Priority Data
Sep. 30, 2009 (JP) 2009-226252

(51) Int. Cl. H04N 9/31

(52) U.S. Cl. 353/58; 348/744; 353/61; 348/E09.025

(57) ABSTRACT

A video projector including a cooling current discharging structure capable of providing a high-speed cooling current and a low-speed cooling current to an optical component of an optical system serving as a cooling subject. The cooling current discharging structure discharges the high-speed cooling current toward a high-temperature region of the optical component and discharges the low-speed cooling current toward a low-temperature region having a relatively low temperature.

### CROSS-REFERENCE TO RELATED APPLICATIONS

This application is based upon and claims the benefit of priority from prior Japanese Patent Application No. 2009-226252, filed on Sep. 30, 2009, the entire contents of which are incorporated herein by reference.

### BACKGROUND OF THE INVENTION

The present invention relates to a video projector, and more particularly to a video projector that cools an optical component with a cooling current.

In the prior art, a video projector includes optical systems that are arranged in a housing. The optical systems include an illumination optical system having a light source or the like, a splitting optical system that splits illumination light into a red light, green light, and blue light, light valves modulating the colored lights in accordance with video information, a combining optical system that combines the modulated lights, and a projector lens enlarging and projecting the combined light. Due to the increased illuminance of images, recent projectors use light sources that emit a large amount of light. Further, recent projectors have become more compact. This has resulted in a tendency for heat to build up inside the projectors. It is thus important for optical components vulnerable to heat to be cooled, such as an emission side polarizing plate of a light valve and a polarizing beam splitter (PBS) of the illumination optical system.

These optical components are generally cooled by delivering a flow of air from a blower to a subject to be cooled (cooling subject) through a duct and supplying a predetermined amount of air to a predetermined location with a deflection plate and a nozzle. Japanese Laid Open Patent Publication Nos. 2007-298890 and 2000-81667 describe prior art examples of such a cooling scheme.

In the prior art cooling scheme described above, the amount of air and blowing location of a nozzle are selected in accordance with the cooled optical component. This is because the optical components that are cooled have different temperature rising rates and different tolerable temperature limits. However, in an optical component that is vulnerable to heat such as those described above, the temperature does not rise evenly in the entire optical component. Thus, the temperature distribution is not uniform. More specifically, as shown in FIG. 1, there is a tendency for the temperature to be higher at a central portion in which a large amount of light is concentrated, and there is a tendency for the temperature to be lower as a peripheral portion becomes closer. However, in the prior art cooling scheme, the blower cools such an optical component entirely by blowing air against the optical component. Such a cooling scheme does not take into consideration the temperature distribution of the cooled optical component. Since a temperature rise in part of an optical component would be dealt with by increasing the entire amount of air, when a projector uses a light source emitting an increased amount of light and has a smaller size, the amount of air would be significantly increased. This would lower efficiency and increase noise.

### SUMMARY OF THE INVENTION

The present invention provides a video projector that efficiently cools an optical component, while taking into consideration the temperature distribution of the optical component.

One aspect of the present invention is a video projector provided with an optical system, which includes an optical component, and a cooling current discharging structure, which is capable of providing a high-speed cooling current and a low-speed cooling current to the optical component of the optical system. The optical component serves as a cooling subject. The cooling current discharging structure discharges the high-speed cooling current toward a high-temperature region of the optical component and discharges the low-speed cooling current toward a low-temperature region having a relatively low temperature.

A further aspect of the present invention is a video projector provided with an optical system, which includes an optical component, and a cooling current discharging structure, which provides first and second airflow cooling currents to the optical component of the optical system in which one of the airflow cooling currents has a higher flow speed than the other of the airflow cooling currents. The optical component serves as a cooling subject. The cooling current discharging structure discharges the one of the airflow cooling currents having a higher flow speed toward a first region of the optical component and discharges the other of the airflow cooling currents toward a second region of the optical component in which the first region when the optical system is operating has a higher temperature than the second region.

Other aspects and advantages of the invention will become apparent from the following description, taken in conjunction with the accompanying drawings, illustrating by way of example the principles of the invention.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale. In the drawings, like numerals are used for like elements throughout:

FIG. 1 is a chart showing the general temperature distribution in an optical component;

FIG. 2 is a schematic view showing optical systems of a representative video projector according to one embodiment of the present invention;

FIG. 3 is a plan view showing a light valve for a red light and its surroundings in the video projector of FIG. 1.

FIG. 4 is a cross-sectional view taken along line A-A in FIG. 3;

FIG. 5 is a cross-sectional view taken along line B-B in

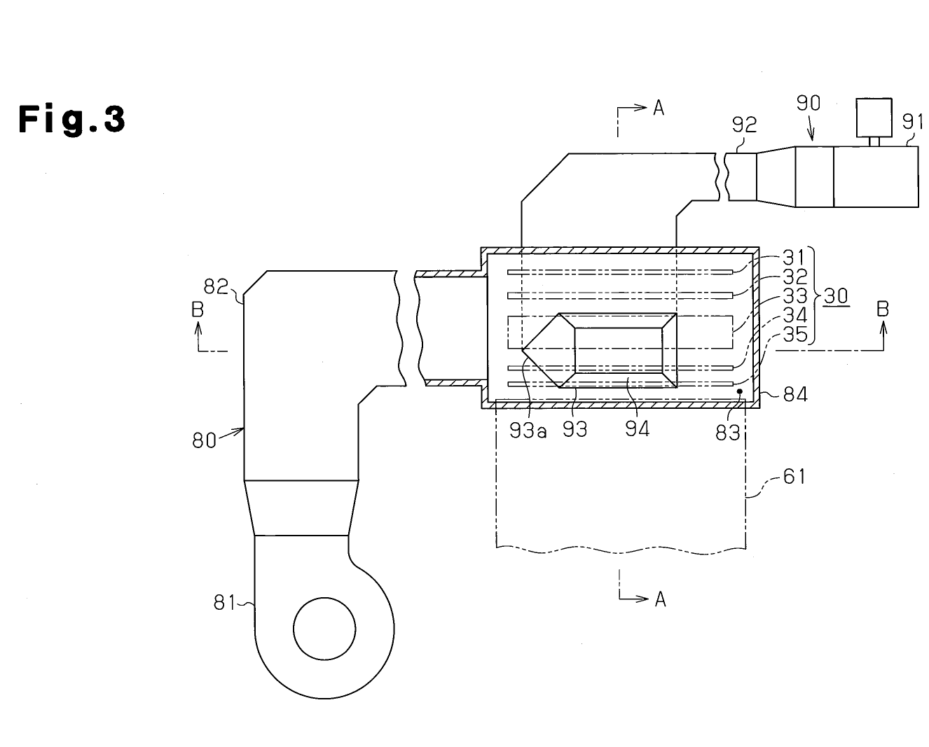

FIG. 3;

FIG. 6 is a cross-sectional view of a blower chamber for a low-speed air passage in a modification of the video projector;

FIG. 7 is a cross-sectional plan view of a high-speed air passage in a modification of the video projector; and

FIG. 8 is a perspective view showing an engaging portion formed at a distal portion of the high-speed air passage in a modification of the video projector.

### DETAILED DESCRIPTION OF THE INVENTION

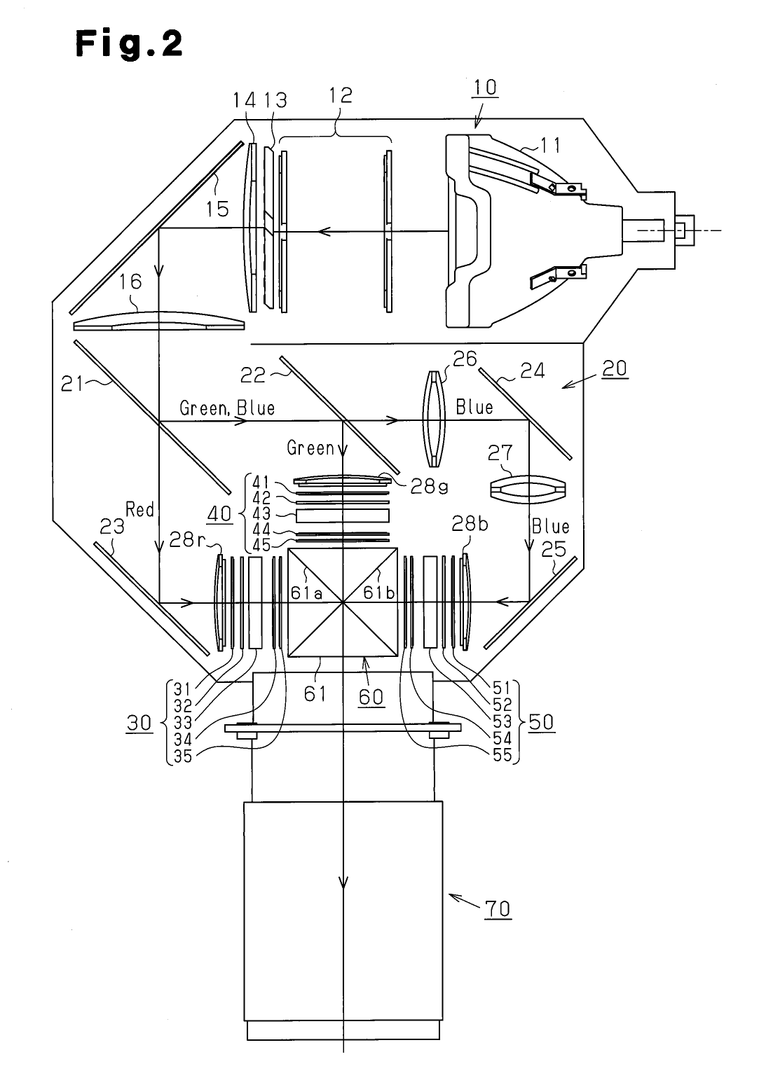

Optical systems in a video projector according to the present invention will first be described with reference to FIG. 2.

The video projector is a liquid crystal display (LCD) video projector and is of a three-panel type in this example. Optical systems of the projector include an illumination optical system 10, which emits illumination light, and a color splitting optical system 20, which splits the illumination light emitted from the illumination optical system 10 into a red light, green light, and blue light. The optical systems further include a red light valve 30, a green light valve 40, and a blue light valve 50 respectively modulating the red light, green light, and blue light split by the color splitting optical system 20. The optical systems also include a color combining optical system 60, which combines the modulation lights modulated by the light valves 30, 40, and 50, and a projection optical system 70, which enlarges and projects the combined light emitted from the color combining optical system 60 as a colored image light onto a screen or the like.

The illumination optical system 10 includes a light source lamp 11, an integrator lens 12, a polarizing beam splitter 13, a condenser lens 14, a reflection mirror 15, and a relay lens 16. A light beam is emitted from the light source lamp 11 toward the integrator lens 12, which includes a first lens array arranged at an entry side and a second lens array arranged at an emission side. A plurality of cell lenses in the first lens array divides the light beam emitted to the integrator lens 12 into a plurality of fine partial light beams. Then, each of the partial light beams emitted from the first lens array is converged on a corresponding cell lens in the second lens array. Further, the polarizing beam splitter 13 gathers the light beams emitted from the integrator lens 12 and forms predetermined polarized light, which is emitted via the condenser lens 14, reflection mirror 15, and relay lens 16 to the color splitting optical system 20.

The color splitting optical system 20 includes dichroic mirrors 21 and 22, reflection mirrors 23, 24, and 25, relay lenses 26 and 27, condenser lenses 28r, 28g, and 28b and function to split the illumination light emitted from the illumination optical system 10 into a red light, a green light, and a blue light.

The first dichroic mirror 21 transmits red light and reflects green light and blue light. The red light transmitted through the first dichroic mirror 21 is reflected by the reflection mirror 23 and transmitted through the condenser lens 28r to illuminate the red light valve 30. The condenser lens 28r converges the partial light beams from the illumination optical system 10 at the red light valve 30 to form a light beam in which the partial light beams are substantially parallel to one another. The condenser lenses 28g and 28b respectively arranged at the entry sides of the green light valve 40 and the blue light valve 50 are formed in a manner similar to the condenser lens 28r.

Among the green light and blue light reflected by the first dichroic mirror 21, the green light is reflected by the second dichroic mirror 22 and transmitted through the condenser lens 28g to illuminate the green light valve 40. In contrast, the blue light is transmitted through the second dichroic mirror 22 and sequentially travels to the relay lens 26, the reflection mirror 24, the relay lens 27, the reflection mirror 25, and the condenser lens 28b to illuminate the blue light valve 50.

The red light valve 30 includes an entry side polarizing plate 31 arranged at the entry side, an optical compensation plate 32, a transmissive liquid crystal panel 33, a pre-polarizing plate 34, and an emission side polarizing plate 35 in a manner similar to the structure of the prior art. The green light valve 40 includes an entry side polarizing plate 41 arranged on the entry side, an optical compensation plate 42, a transmissive liquid crystal panel 43, a pre-polarizing plate 44, and an emission side polarizing plate 45 arranged on the emission side. The blue light valve 50 includes an entry side polarizing plate 51 arranged on the entry side, an optical compensation plate 52, a transmissive liquid crystal panel 53, a pre-polarizing plate 54, and an emission side polarizing plate 55 arranged on the emission side.

The color combining optical system 60 includes a cross dichroic prism 61. The cross dichroic prism 61 has a reflection surface 61a, which reflects the red light modulated by and emitted from the red light valve 30, and a reflection surface 61b, which reflects the blue light modulated by and emitted from the blue light valve 50. The red and blue lights, which enter the cross dichroic prism 61 and are reflected by the reflection surfaces 61a and 61b, are combined with the green light, which enters and transmits straight through the cross dichroic prism 61. The combined light is emitted from the cross dichroic prism 61 as a colored image.

The projection optical system 70 is arranged at the emission side of the cross dichroic prism 61 and includes a projector lens unit.

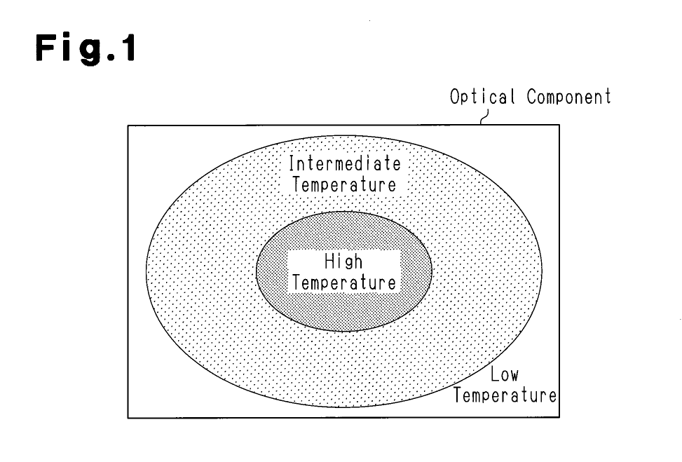

In such optical systems, the light source increases the temperature. Further, the polarizing beam splitter 13 and the light valves 30, 40, and 50 are formed by optical components having a relatively low tolerable temperature limits. In this case, the temperature increases is highest at the emission side polarizing plates 35, 45, and 55, which regulate the amount of emitted light. Further, the central portion of each of these optical components receives a larger amount of light from the light source. Thus, there is a tendency for the temperature to be higher at the central portion and lower as the peripheral portion becomes lower as shown in FIG. 1.

A cooling structure for optical components according to the present invention will now be discussed with reference to FIGS. 3 to 5. Here, the red light valve 30 will be used as an example for describing the cooling structure. FIG. 3 is a plan view. In the following description, the vertical direction refers to a direction perpendicular to the plane of FIG. 3, with the upper side of FIG. 3 being defined as the upper side.

FIG. 3 is a schematic plan view showing the cooling structure for cooling the optical components of the red light valve 30 with a cooling current. As viewed in the drawing, a double duct type air conduit is formed below the optical components of the red light valve 30. More specifically, the air conduit includes an outer air passage and an inner air passage. The outer air passage is a low-speed air passage 80 through which air flows at a low speed, and the inner air passage is a high-speed air passage 90 through which air flows at a high speed.

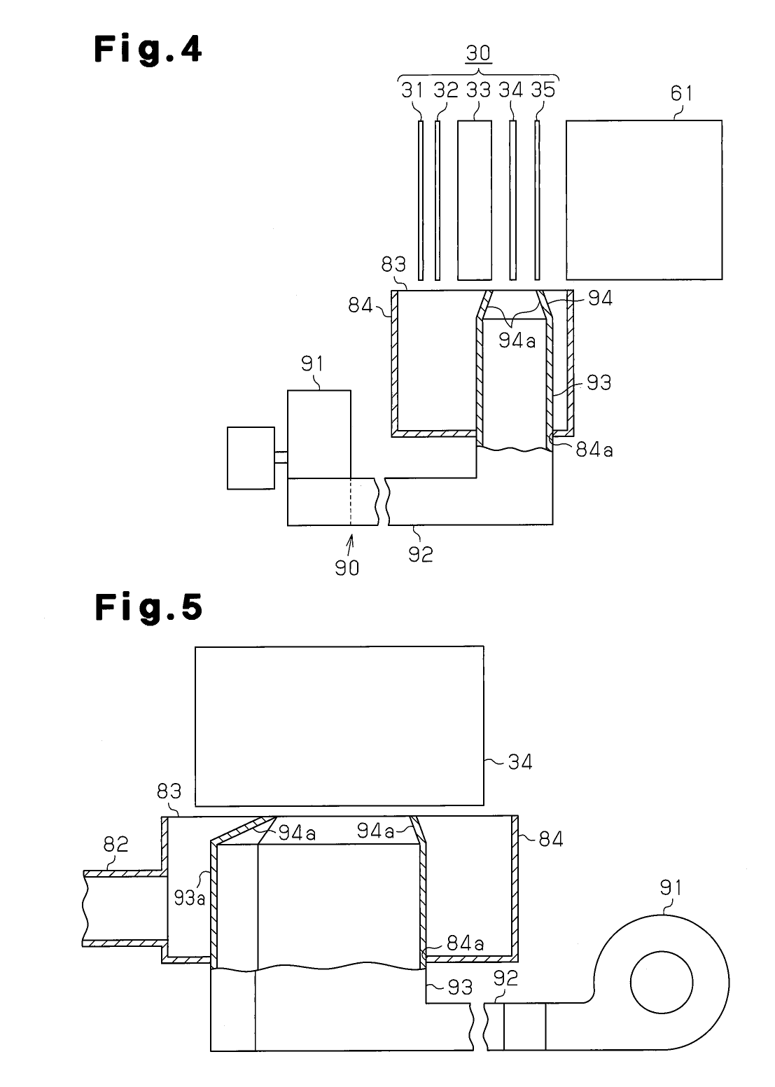

The low-speed air passage 80 includes a blower 81, a blower duct 82 connected to the outlet side of the blower 81, a blower port 83 that discharges a cooling current toward the optical components of the red light valve 30 from below (refer to FIG. 4), and a blower chamber 84 formed ahead of the blower port 83.

A normal low pressure fan, such as a sirocco fan, of which the specifications are suitable for discharging an air current from the blower port 83 at a low speed, is used as the blower 81. The blower duct 82 provides a cooling current airway to the blower chamber 84 through a side wall thereof. In the present embodiment, the blower port 83 is formed with a shape that opens upwardly from the blower chamber 84. The dimension of the blower port 83 in the lateral direction of FIG. 3 (direction perpendicular to the light axis) is set to be slightly greater than the lateral dimensions of the optical components (light valve 30 in this case). The dimension of the blower port 83 in the light axis direction is set to be large enough to include the entry side polarizing plate 31 to the emission side polarizing plate 35 (refer to FIG. 4). In this manner, the blower port 83 is formed so as to discharge a predetermined amount of cooling current airflow at predetermined speed over the entire range of optical components in the light valve 30 excluding the portion in which a high-speed cooling current is discharged from a nozzle 94 of the high-speed air passage 90. The cooling current discharged from the blower port 83 is slower than the cooling current discharged from the nozzle 94. Thus, in this specification, the cooling current discharged from the blower port 83 is referred to as a low-speed current, and the cooling current discharged from the nozzle 94 is referred to as a high-speed current.

The high-speed air passage 90 includes a blower 91, a blower duct 92 connected to the outlet side of the blower 91, an inner duct 93 inserted inside the blower chamber 84, and a nozzle 94 formed at the distal portion of the high-speed air passage 90, that is, at the distal portion of the inner duct 93 in the present embodiment.

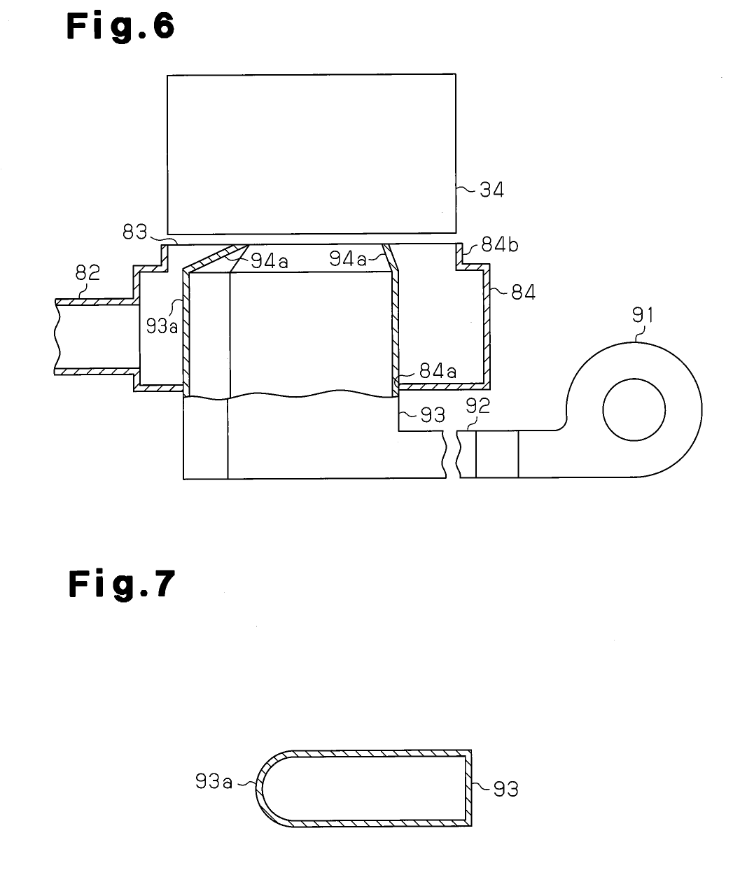

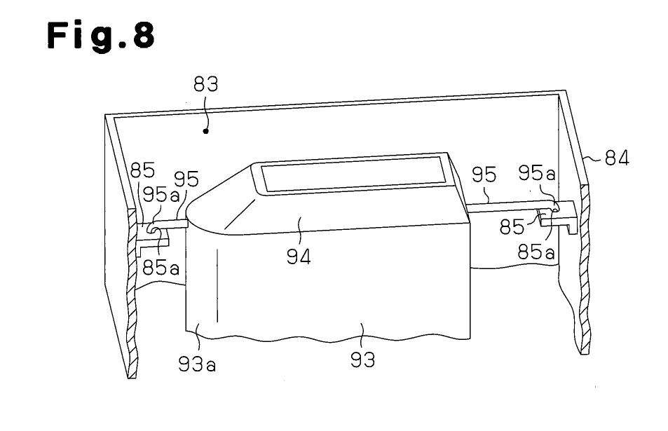

A high pressure fan, such as a turbo fan, of which the specifications are suitable for discharging an air current from the nozzle 94 at a high speed, is used as the blower 91. The blower duct 92 extends upward from the lower surface of the blower chamber 84. The inner duct 93, which is a duct portion arranged in the blower chamber 84, is supported in the blower chamber 84 by a portion connected to the blower duct 92. The inner duct 93 includes a side surface 93a formed to have a horizontal cross-section that is tapered (triangular in the present embodiment) toward the air current flowing from the sideward blower duct 82 (refer to FIGS. 3 and 5). The side surface 93a allows for the air current drawn in from the blower duct 82 to flow smoothly to the rear of the inner duct 93, that is, to the right as viewed in FIG. 3.

As shown in FIG. 3, the nozzle 94 is arranged to cool the central portions of the pre-polarizing plate 34 and the emission side polarizing plate 35, which are located at the light emission side where there is a tendency for the temperature to easily increase. As apparent from FIG. 3, the nozzle 94 is formed with a dimension that covers the liquid crystal panel 33, the pre-polarizing plate 34, and the emission side polarizing plate 35 of the red light valve 30 in the light axis direction. Further, in the lateral direction perpendicular to the light axis, the size and location of the nozzle 94 are set to discharge a high-speed cooling current at predetermined speed to the central portion of the optical component (light valve 30). Further, as shown in FIGS. 4 and 5, the nozzle 94 has tapered portions 94a that are sloped so that its dimensions become smaller as the distal end (i.e., top end) becomes closer.

The structure for strongly cooling the central portions of the pre-polarizing plate 34 and the emission side polarizing plate 35 has been described above. In the video projector according to the present embodiment, the pre-polarizing plate 44 and emission side polarizing plate 45 in the green light valve 40 and the pre-polarizing plate 54 and emission side polarizing plate 55 in the blue light valve 50 are also cooled in the same manner.

In the video projector, the optical components are cooled as described below.

Some of the optical components in the optical systems are vulnerable to heat, for example, the entry side polarizing plates 31, 41, and 51, the optical compensation plates 32, 42, and 52, the liquid crystal panels 33, 43, and 53, the pre-polarizing plates 34, 44, and 54, and the emission side polarizing plates 35, 45, and 55 of the light valves 30, 40, and 50. The polarizing beam splitter 13 is also vulnerable to heat. Further, the temperature distribution is not uniform in such optical components as shown in FIG. 1, and the temperature has a tendency of being higher at the central portions of such optical components in surfaces perpendicular to the light axis. That is, in each of such optical components, the central portion forms a high-temperature region, and the peripheral portion forms a low-temperature region having relatively low temperature. Among these optical components, the rise in temperature is highest in the pre-polarizing plates 34, 44, and 54 and the emission side polarizing plates 35, 45, and 55. In the present embodiment, in order to strongly cool the high-temperature region in the central portion of each of these optical components especially at the emission side, cooling current is discharged at a high speed from the nozzle 94 by the high-speed, high-pressure blower 91. This lowers the temperature of the high-temperature regions in these optical components and decreases temperature variations. Further, the low-temperature region surrounding the high-temperature region, that is, the peripheral portion of each optical component, is cooled by discharging air from the normal blower 81. The peripheral portion of the optical component is also cooled by a swirling air current generated by the speed difference between the air currents. In this manner, cooling currents of two or more speeds are used. This efficiently cools the optical components. Further, such a structure decreases temperature variations in the optical component and allows for a uniform temperature distribution.

The video projector according to the present embodiment has the advantages described below.

(1) The video projector includes a cooling current discharge structure that discharges high-speed cooling current to the high-temperature region of an optical component and discharges a low-speed cooling current to the low-temperature region at which the temperature is relatively low. By using such a finely regulated cooling means, cooling is performed without using unnecessary amounts of air and unnecessary current speeds. This improves the cooling effect and efficiency, while reducing noise. Further, temperature variations are decreased in the optical components and the cooling capacity is increased. Thus, the reliability and durability of the optical components are improved.

(2) The nozzle 94 that discharges the cooling current is formed at the distal end of the high-speed air passage 90. This efficiently discharges cooling current to the high-temperature regions of the optical components and thereby increases the cooling capacity.

(3) The nozzle 94, which discharges the high-speed cooling current, is located inside the blower port 83, which discharges the low-speed cooling current. Further, the periphery of the nozzle 94 is surrounded by the low-speed cooling current. Accordingly, a cooling current optimal for the temperature distribution of the cooled optical component is discharged from the nozzle 94. Further, the cooling current directed to the peripheral portion of the optical component draws in surrounding air due to the pressure difference corresponding to the current speed difference. This reduces the amount of air used to cool the peripheral portion and further improves efficiency.

(4) The nozzle 94 formed at the distal end of the high-speed air passage 90 is arranged in the blower port 83 formed at the distal end of the low-speed air passage 80. Accordingly, the high-speed air passage 90 and the low-speed air passage 80 form a double duct at least at a location just ahead of the blower port 83. This simplifies the structures for a cooling current passage for a cooling subject.

(5) The blower chamber 84 is provided ahead of the blower port 83 in the low-speed air passage 80, and the blower duct 92 connected to the blower 91 in the high-speed air passage 90 is inserted in the blower chamber 84. This forms a double duct. Accordingly, the inner duct 93 in the high-speed air passage 90 is supported by the low-speed air passage 80. This facilitates the mounting of the high-speed air passage 90.

(6) The blower duct 82 in the low-speed air passage 80 is connected to the side wall of the blower chamber 84, and the high-speed air passage 90 includes the side surface 93a, which has a horizontal cross-section tapered toward the air current from the blower duct 82. Accordingly, the flow of air drawn from the blower duct 82 into the low-speed air passage 80 is smoothly guided to the rear of the high-speed air passage (inner duct 93), that is, toward the right as viewed in FIG. 3. This forms a uniform low-speed air current around the high-speed air passage 90.

(7) The blower 91 for generating the high-speed cooling current and the blower 81 for generating the low-speed cooling current are different types of blowers, and the blower 91 is more suitable for generating high-pressure air current than the blower 81. Accordingly, air currents are generated at speeds optimal for their applications (i.e., temperature regions).

It should be apparent to those skilled in the art that the present invention may be embodied in many other specific forms without departing from the spirit or scope of the invention. Particularly, it should be understood that the present invention may be embodied in the following forms.

The cooling structure of the above-discussed embodiment cools the pre-polarizing plates 34, 44, and 54 and the emission side polarizing plates 35, 45, and 55 with cooling currents of two speeds. In the same manner, any component having a temperature distribution variation such as the other optical components in the light valves 30, 40, and 50, the polarizing beam splitter 13, and the light source may also be cooled by cooling currents of two speeds.

As shown in FIG. 6, the blower port 83 discharging the low-speed cooling current may have an opening area that is smaller than the cross-sectional area of the blower chamber 84. More specifically, the upper end of the blower chamber 84 may be bent inward and then upward to form an upright wall 84b that defines the blower port 83. In this structure, the blower port 83 is narrower than the blower chamber 84. This moderates the effect of dynamic pressure produced by the air current drawn into the blower duct 82 and uniformly distributes the speed of the air current discharged from the blower port 83. Further, the upright wall 84b may function as a deflection plate.

The side surface 93a of the inner duct 93 located at the outlet side of the blower duct 82 is not required to have a tapered triangular shape and may be, for example, semicircular in shape (refer to FIG. 7) or semielliptical. Such forms would also allow for air to smoothly flow from the low-speed air passage 80 toward the rear of the inner duct 93 (toward the right in FIG. 3).

An engaging portion for positioning the high-speed air passage 90 relative to the low-speed air passage 80 may be arranged at the distal portion of the high-speed air passage 90, which includes the nozzle 94. In this case, in addition to fixing the inner duct 93 to an insertion portion 84a, but the nozzle 94 may be positioned with further accuracy. This accurately discharges cooling current to the region subject to cooling. FIG. 8 shows an example of an engaging portion. Arms 95 extend from near the nozzle 94 toward the top end of the blower chamber 84. Each arm 95 has a distal portion forming an engaging portion 95a, which is rod-shaped and curved and thereby has a circular cross-section. The blower chamber 84 includes supports 85, each having an engaging portion 85a formed by a hole for insertion of the corresponding engaging portion 95a. Accordingly, insertion of the rod-shaped curved engaging portions 95a into the holes of the engaging portions 85a stabilizes the position and direction of the nozzle 94 and accurately adjusts the direction of the cooling current.

In the above-discussed embodiment, as apparent from FIG. 3, the low-speed air passage 80 is formed so that the blower duct 82 has a cross-sectional area smaller than that of the blower chamber 84 the low-speed air passage 80. However, the low-speed air passage 80 is not limited to such a structure, and the cross-sectional area of the blower duct 82 may be larger depending on available space. In the same manner, it is obvious that the blower duct 92 of the high-speed air passage 90 may have a larger cross-section.

The blower port 83 formed in the distal portion of the low-speed air passage 80 may include deflection to further finely adjust the amount and speed of the air current directed to a region subject to cooling. In the same manner, the nozzle 94 in the high-speed air passage 90 may also include such a mechanism.

The present examples and embodiments are to be considered as illustrative and not restrictive, and the invention is not to be limited to the details given herein, but may be modified within the scope and equivalence of the appended claims.

What is claimed is:

1. A video projector comprising:
an optical system including an optical component; and
a cooling current discharging structure capable of providing a high-speed cooling current and a low-speed cooling current to the optical component of the optical system, the optical component serving as a cooling subject, wherein the cooling current discharging structure discharges the high-speed cooling current toward a high-temperature region of the optical component and discharges the low-speed cooling current toward a low-temperature region having a relatively low temperature.

2. The video projector according to claim 1, wherein the cooling current discharging structure includes a high-speed air passage having a nozzle that discharges the high-speed cooling current.

3. The video projector according to claim 1, wherein the cooling current discharging structure further includes a low-speed air passage that discharges the low-speed cooling current and surrounds the nozzle of the high-speed air passage to form a double duct.

4. The video projector according to claim 2, wherein the cooling current discharging structure includes a blower port that discharges the low-speed cooling current, and the nozzle that discharges the high-speed cooling current is located in the blower port so as to be surrounded by the discharged low-speed cooling current.

5. The video projector according to claim 4, wherein the cooling current discharging structure includes a low-speed air passage having the blower port that discharges the low-speed cooling current;
the blower port is formed at a distal end of the low-speed air passage;
the nozzle is formed at a distal end of the high-speed air passage; and
the low-speed air passage and the high-speed air passage form a double duct located at least ahead of the blower port.

6. The video projector according to claim 5, wherein the low-speed air passage includes:
a first blower;
a first blower duct connected to the first blower; and
a blower chamber connected to the first blower duct and located ahead of the blower port; and
the high-speed air passage includes:
a second blower;
a second blower duct connected to the second blower; and
an inner duct connected to the second blower duct, inserted in the blower chamber, and supported by the blower chamber.

7. The video projector according to claim 6, wherein the first blower duct in the low-speed air passage is connected to a side wall of the blower chamber; and
the inner duct in the high-speed air passage includes a side surface having a horizontal cross-section tapered toward a flow of air drawn in from the first blower duct.

8. The video projector according to claim 7, wherein the blower port discharging the low-speed cooling current is defined by an upright wall formed by bending an upper end of the blower chamber inward and upward, and the blower part has an opening area that is smaller than a cross-sectional area of the blower chamber.

9. The video projector according to claim 3, wherein the high-speed air passage includes a first engaging portion arranged near the nozzle, and the low-speed air passage includes a second engaging portion engaged with the first engaging portion.

10. The video projector according to claim 1, wherein the first blower and the second blower are different types of blowers, and the second blower is a blower more suitable for generating high-pressure air current than the first blower.

11. A video projector comprising:
an optical system including an optical component; and
a cooling current discharging structure that provides first and second airflow cooling currents to the optical component of the optical system in which one of the airflow cooling currents has a higher flow speed than the other of the airflow cooling currents, the optical component serving as a cooling subject, wherein the cooling current discharging structure discharges the one of the airflow cooling currents having a higher flow speed toward a first region of the optical component and discharges the other of the airflow cooling currents toward a second region of the optical component in which the first region when the optical system is operating has a higher temperature than the second region.

12. The video projector according to claim 11, wherein the cooling current discharging structure includes a high-speed air passage having a nozzle that discharges the one of the airflow cooling currents having a higher flow speed.

13. The video projector according to claim 11, wherein the cooling current discharging structure further includes a low-speed air passage that discharges the other of the airflow cooling currents and surrounds the nozzle of the high-speed air passage to form a double duct.

14. The video projector according to claim 12, wherein the cooling current discharging structure includes a blower port that discharges the other of the airflow cooling currents, and the nozzle that discharges the one of the airflow cooling currents having a higher flow speed is located in the blower port so as to be surrounded by the discharged other of the airflow cooling currents.

15. The video projector according to claim 14, wherein the cooling current discharging structure includes a low-speed air passage having the blower port that discharges the other of the airflow cooling currents;
the blower port is formed at a distal end of the low-speed air passage;
the nozzle is formed at a distal end of the high-speed air passage; and
the low-speed air passage and the high-speed air passage form a double duct located at least ahead of the blower port.

16. The video projector according to claim 15, wherein the low-speed air passage includes:
a first blower;
a first blower duct connected to the first blower; and
a blower chamber connected to the first blower duct and located ahead of the blower port; and
the high-speed air passage includes:
a second blower;
a second blower duct connected to the second blower; and
an inner duct connected to the second blower duct, inserted in the blower chamber, and supported by the blower chamber.

17. The video projector according to claim 16, wherein the first blower duct in the low-speed air passage is connected to a side wall of the blower chamber; and
the inner duct in the high-speed air passage includes a side surface having a horizontal cross-section tapered toward a flow of air drawn in from the first blower duct.

18. The video projector according to claim 17, wherein the blower port discharging the other of the airflow cooling currents is defined by an upright wall formed by bending an upper end of the blower chamber inward and upward, and the blower part has an opening area that is smaller than a cross-sectional area of the blower chamber.

19. The video projector according to claim 13, wherein the high-speed air passage includes a first engaging portion arranged near the nozzle, and the low-speed air passage includes a second engaging portion engaged with the first engaging portion.

20. The video projector according to claim 11, wherein the first blower and the second blower are different types of blowers, and the second blower generates a higher pressure air current than the first blower.
